(19) United States
(12) Patent Application Publication
(10) Pub. No.: US 2008/0216275 A1
(43) Pub. Date: Sep. 11, 2008

(54) Arrangement for the Attachment of a Wiping Mechanism

(75) Inventors: Laurent Collinet, La Roche Posay (FR); Pascal Morin, Chatellerault (FR)

Correspondence Address: OSHA LIANG L.L.P., 1221 MCKINNEY STREET, SUITE 2800, HOUSTON, TX, 77010, US

(73) Assignee: Valeo Systemes d'Essuyage, La Verriere (FR)

(21) Appl. No.: 11/547,535

(22) PCT Filed: Mar. 30, 2005
(86) PCT No.: PCT/EP05/03317

§ 371 Date: Apr. 11, 2008

(30) Foreign Application Priority Data
Apr. 1, 2004 (FR) 04 03462

(51) Int. Cl. B60S 1/04

(52) U.S. Cl. 15/250.31

(57) ABSTRACT

The invention provides an arrangement of the type that comprises a spacer which is attached to the body structure element, and an attachment tab (12) in which the front longitudinal end (12a) is attached to the spacer by means of a shock absorber element (16) with a tubular shape that is coaxial in relation to the spacer and in which the outer cylindrical wall comprises a peripheral groove with the attachment tab (12) resting against the bottom (22) of said groove, and of the type in which the front end of the attachment tab (12) comprises a C-shaped housing (20) in which the shock absorber element (16) is accommodated, characterised in that longitudinal free play exists between the rear section (28) and the bottom (22) of the peripheral groove (18) opposite it.

The invention provides an arrangement for the installation and attachment of a wiping mechanism that comprises a shock absorber element, enabling a reduction of the noise generated by the vibrations of the drive mechanism, as well as possible positioning errors due to elastic deformations of the shock absorber element.

The invention relates more particularly to an arrangement for the installation and attachment of a support plate, in particular of a support plate for a windscreen wiper mechanism, to a body structure element of a motor vehicle, which comprises:
a spacer with an overall cylindrical shape that rotates about a vertical main axis (A), which is fixed to the body structure element, and
an overall horizontal attachment tab, made as a single part with the support plate, which extends following a main longitudinal direction towards the front from the support plate and in which the front longitudinal end is attached to the spacer by means of a shock absorber element placed between the attachment tab and the spacer,

the arrangement being of the type in which:
the shock absorber element is an element with a tubular shape that is coaxial with the spacer, in which the outer cylindrical wall comprises a peripheral groove, with the attachment tab resting against the bottom of said groove,
the front end of the attachment tab comprises a C-shaped housing in which the shock absorber element is accommodated, which is delimited by two concave sections that are opposite to each other and complement the bottom of the peripheral groove, so as to position the attachment tab coaxially in relation to the shock absorber element, two front sections in which the average distance between the front sections is less than the outside diameter of the bottom of the peripheral gorge in order to provide the blocking of the shock absorber element in the C-shaped housing, and a rear section connecting the concave sections.

Current motor vehicles generally comprise a drive mechanism associated with each wiper blade, whether for wiping the rear transversal window panel or the front windscreen of the vehicle.

Each of these drive mechanisms comprises a shaft that drives the wiper blade, which is driven in rotation by an electric motor and guided in rotation by a bearing.

In a known manner, the drive mechanism is attached to a plate which is, in turn, attached by three points to a body structure element of the vehicle, so as to ensure the immobilisation of the wiping device, and to prevent it from rotating in relation to the window panel.

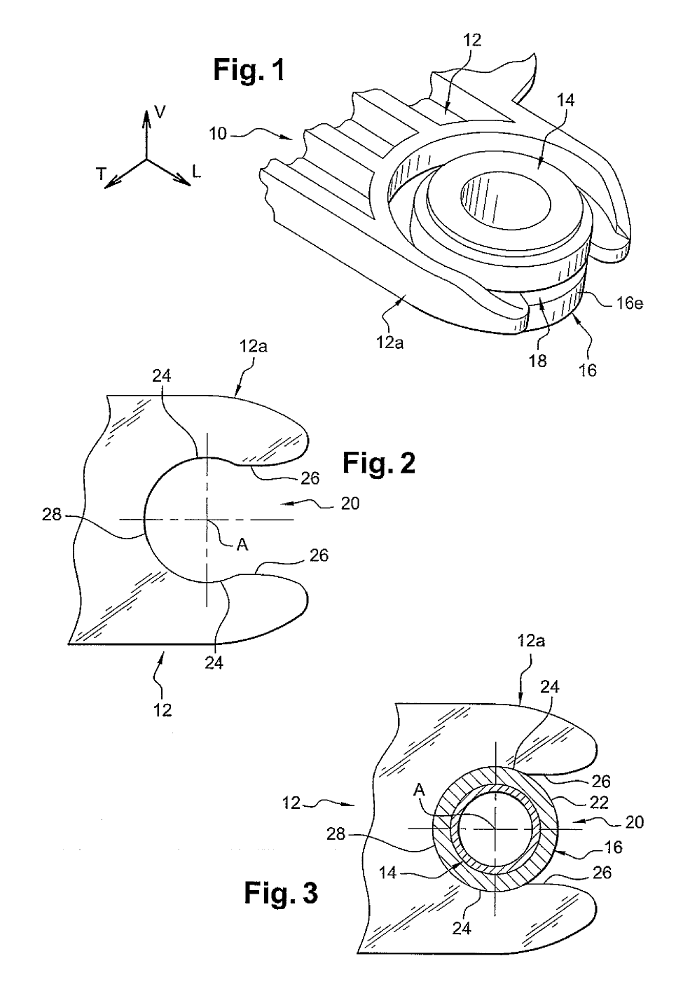

FIGS. 1 to 3 show an embodiment of the means used for installing and attaching a support plate 10 on a body structure element of the vehicle.

The plate 10 comprises for this purpose a horizontal attachment tab 12 that extends longitudinally towards the front, and in which the free front end 12a is attached to a spacer 14 of the body structure element, by means of a shock absorber element 16 made from an elastic material.

The shock absorber element 16 is an element with an overall tubular shape, and its outer cylindrical wall 16e comprises a peripheral groove 18, the free end 12a of the attachment tab 12 resting against the bottom 22 of said groove.

As shown in FIG. 2, the housing 20 is delimited by two concave sections 24, which are axially opposite to each other, and which complement the bottom 22 of the peripheral groove 18. These concave sections 24 cooperate with the bottom 22 of the peripheral groove 18 so as to ensure that the front end 12a of the tab 12 is positioned coaxially in relation to the shock absorber element 16.

The housing 20 is also delimited by two front longitudinal sections 26, between which the shock absorber element 16 is inserted in the housing 20. The average distance between the two front longitudinal sections 26 is less than the outside diameter of the bottom 22 of the peripheral groove 18 so as to ensure the blocking of the shock absorber element 16 in the housing 20.

Finally, the housing 20 is delimited by a rear section 28 that connects the concave sections 24.

As shown in FIG. 3, the concave sections 24 and the rear section 28 form a single arc of circle centred on the axis A of the spacer 14, and complement the bottom 22 of the peripheral groove 18.

In this way, the rear section 28 is resting against the bottom 22 of the peripheral groove 18.

And yet, in a general manner, the shock absorber element 16 is mounted tightly inside the housing 20, which causes a radial deformation of the shock absorber element 16.

However, only the portion of the shock absorber element 16 that is located between the two front sections 26 of the housing 20 is capable of deforming freely.

The shock absorber element 16 is not therefore capable of deforming symmetrically in relation to its vertical axis A, which causes an offset of the attachment tab 12, and therefore a positioning error of the plate 10.

The invention has the objective of providing an arrangement for the installation of the plate, in which the installation of the shock absorber element in the housing 20 of the attachment tab 12 does not cause an offset of the attachment tab 12.

With this objective, the invention provides an arrangement of the type described above, characterised in that longitudinal free play exists between the rear section and the bottom of the peripheral groove.

According to other characteristics of the invention:
each concave section consists of an arc of circle centred on the vertical axis A of the spacer;
each concave section comprises a radial indentation with a transversal main axis;
each concave section is symmetrical in relation to an transversal axial plane;
the C-shaped housing is symmetrical in relation to an longitudinal axial plane;
the shock absorber element comprises a rear vertical transversal flat section located opposite the rear section of the C-shaped housing.

Further characteristics and advantages of the invention will appear from reading the following detailed description, for the understanding of which the appended figures can be consulted, in which:

FIG. 1 is a diagrammatic perspective view of an arrangement for the installation of the support plate according to the instructions of the prior art;

FIG. 2 is a horizontal section view of the attachment tab shown in FIG. 1;

FIG. 3 is a horizontal section view of the arrangement shown in FIG. 1;

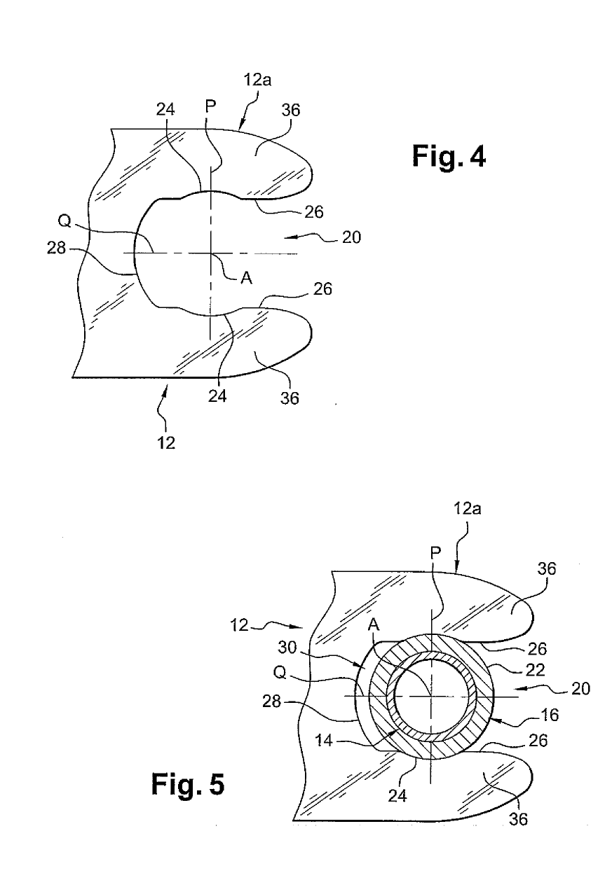

FIG. 4 is a view similar to that shown in FIG. 2, showing an attachment tab according to the invention;

FIG. 5 is a view similar to that shown in FIG. 3, showing the arrangement comprising the attachment tab shown in FIG. 4;

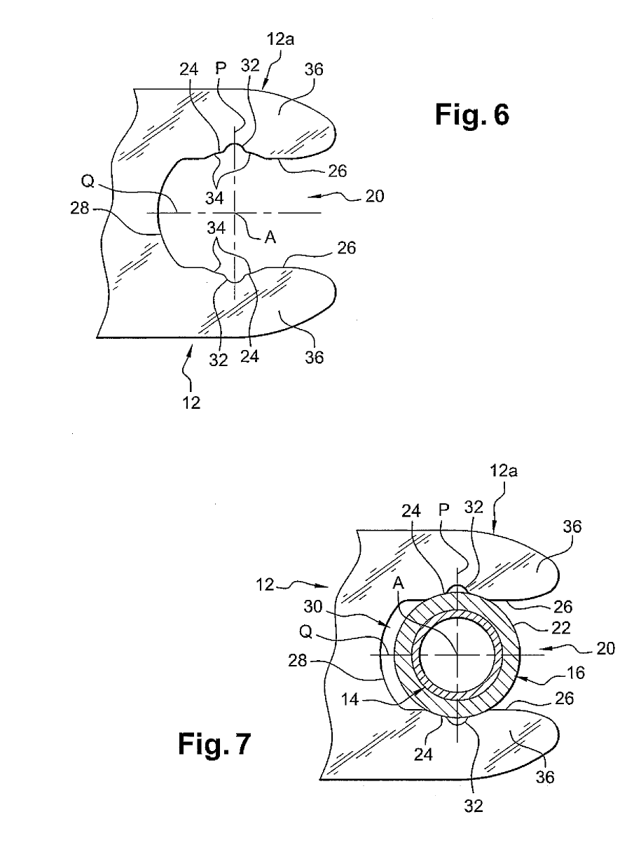

FIG. 6 is a view similar to that shown in FIG. 2, showing an attachment tab according to the invention;

FIG. 7 is a view similar to that shown in FIG. 3, showing the arrangement comprising the attachment tab shown in FIG. 6;

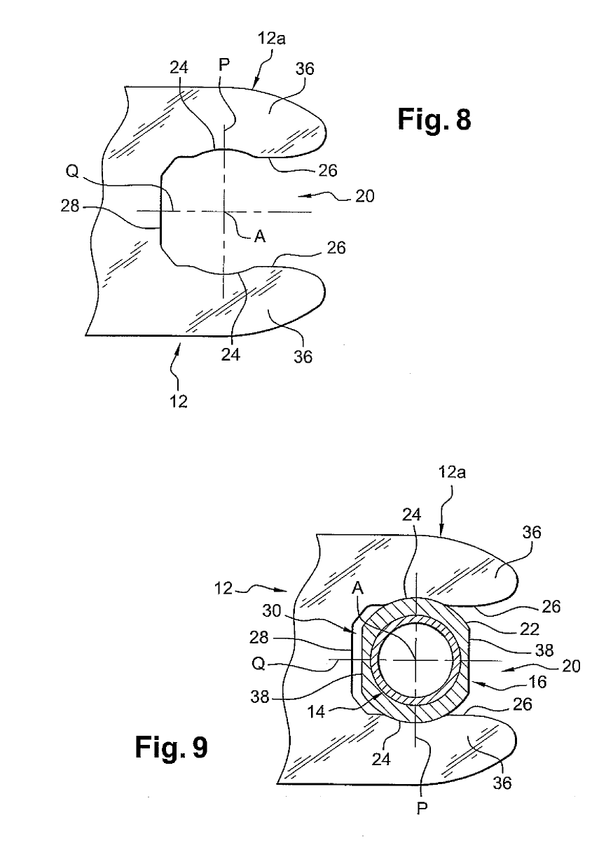

FIG. 8 is a view similar to that shown in FIG. 2, showing an attachment tab according to the invention;

FIG. 9 is a view similar to that shown in FIG. 3, showing the arrangement comprising the attachment tab shown in FIG. 8.

For the description of the invention, the orientations vertical, longitudinal and transversal will be adopted non-limitingly according to the reference frame V, L, T indicated in the figures.

The orientation front-to-back will also be adopted as being the longitudinal left-to-right direction according to FIG. 1.

In the following description, identical, similar or analogous elements will be referred to using the same reference numbers.

FIG. 4 shows the front end 12a of an attachment tab 12 according to the invention, which comprises a housing 20 in which the bottom 22 of the peripheral groove 18 of the shock absorber element 16 is accommodated.

The housing 20 is delimited by two concave sections 24, two front longitudinal sections 26 and one rear section 28 that connects the concave sections 24.

According to the invention, and as shown in greater detail in FIG. 5, the housing 20 is shaped so that longitudinal free play exists between the rear section 28 of the housing 20 and the bottom 22 of the groove 18.

This free play allows the shock absorber element 16 to deform freely inside the volume 30 that is thus formed to the rear of the housing 20 and, consequently, the shock absorber element 16 deforms symmetrically in relation to its vertical axis A, improving the coaxial position of the attachment tab 12 in relation to this same vertical axis A.

According to a first embodiment of the housing 20, shown in FIGS. 4 and 5, the concave sections 24 are in the shape of an arc of circle centred on the vertical axis A of the spacer 14. This makes it possible to establish a large contact surface between the bottom 22 of the peripheral groove 18 and the concave sections 24.

According to another alternative embodiment of the housing 20, shown in FIGS. 6 and 7, the concave sections 24 each comprise a radial indentation 32 with a transversal main axis, inside of which the shock absorber element 16 is capable of deforming, in order further to improve the positioning of the attachment tab 12.

Each indentation 32 divides the associated concave section 24 into two segments 34 that rest against the bottom 22 of the groove 18.

According to a preferred embodiment of the invention, the segments 34 of the same concave section 24 are symmetrical in relation to a transversal axial plane P, that is to say that each concave section 24 is symmetrical in relation to this transversal axial plane P.

In addition, the housing 20 is symmetrical in relation to a longitudinal axial plane Q, that is to say that the two concave sections 24 are symmetrical in relation to this longitudinal axial plane Q.

In this way, the distribution of the segments 34 makes it possible to ensure a symmetrical deformation of the shock absorber element 16 inside the housing 20, which is therefore not detrimental to the position of the attachment tab 12 in relation to the vertical axis A.

The longitudinal free play between the rear section 28 of the housing 20 and the bottom 22 of the groove 18 enables the shock absorber element 16 to deform in the volume 30 thus formed. However, the housing 20, which divides the front end 12a of the attachment tab 12 into two longitudinal branches 36, is extended longitudinally towards the rear, that is to say that this longitudinal free play increases the length of the longitudinal branches 36.

The increase in the length of the longitudinal branches 36 reduces the rigidity that holds the shock absorber element 16 in the housing 20, and therefore reduces the rigidity of the front end 12a of the attachment tab 12.

To reduce the length of the housing 20, as shown in the FIGS. 8 and 9, the bottom 22 of the peripheral groove 18 comprises a flat section 38 that extends along a transversal vertical plane opposite the rear section 28 of the housing.

This flat section 38 makes it possible to have an overall rectilinear rear section 28 with a transversal main orientation.

The presence of this flat section, however, requires the shock absorber element 16 to be positioned angularly around the vertical axis A. However, in order to facilitate this positioning, the shock absorber element 16 comprises two flat sections 38 that are symmetrical in relation to the vertical axis A.

1. An arrangement for the installation and attachment of a support plate, in particular of a support plate for a windscreen wiper mechanism, to a body structure element of a motor vehicle, which comprises:
a spacer, with an overall cylindrical shape that rotates about a vertical main axis, which is fixed to the body structure element, and
an overall horizontal attachment tab which is made as a single part with the support plate, which extends following a longitudinal main direction towards the front from the support plate, and in which the front longitudinal end is attached to the spacer by means of a shock absorber element placed between the attachment tab and the spacer,
the arrangement being of the type in which:
the shock absorber element is an element with a tubular shape that is coaxial in relation to the spacer, in which the outer cylindrical wall comprises a peripheral groove, with the attachment tab resting against the bottom of said groove,
the front end of the attachment tab comprises a C-shaped housing in which the shock absorber element is accommodated, which is delimited by two concave sections that are opposite to each other and complement the bottom of the peripheral groove, so as to position the attachment tab coaxially in relation to the shock absorber element, two front sections in which the average distance between the front sections is less than the outside diameter of the bottom of the peripheral groove, in order to provide the blocking of the shock absorber element in the C-shaped housing, and a rear section connecting the concave sections,
wherein longitudinal free play exists between the rear section and the bottom of the peripheral groove.

2. The arrangement according to claim 1, wherein each concave section consists of an arc of circle centred on the vertical axis A of the spacer.

3. The arrangement according to claim 1, wherein each concave section comprises a radial indentation with a transversal main axis.

4. The arrangement according to claim 1, wherein each concave section is symmetrical in relation to an transversal axial plane.

5. The arrangement according to claim 1, wherein the C-shaped housing is symmetrical in relation to a longitudinal axial plane.

6. The arrangement according to claim 1, wherein the shock absorber element comprises a rear vertical transversal flat section located opposite the rear section of the C-shaped housing.
